(19) United States
(12) Patent Application Publication
(10) Pub. No.: US 2015/0264210 A1
(43) Pub. Date: Sep. 17, 2015

(54) IMAGE FORMING APPARATUS, CONTROL METHOD FOR THE SAME, AND STORAGE MEDIUM

(71) Applicant: CANON KABUSHIKI KAISHA, Tokyo (JP)

(72) Inventor: Shinichi Ono, Tokyo (JP)

(21) Appl. No.: 14/643,961

(22) Filed: Mar. 10, 2015

(30) Foreign Application Priority Data
Mar. 14, 2014 (JP) 2014-051412

(51) Int. Cl. H04N 1/00

(52) U.S. Cl. CPC H04N 1/00904; H04N 1/00896; H04N 1/00888; H04N 1/00326; H04N 2201/0094

(57) ABSTRACT

An image forming apparatus that communicates with an external device storing a print job received from an information processing apparatus includes a reception unit that receives a login request for logging in to the image forming apparatus, a determination unit that determines whether a print job of a user logged into the image forming apparatus is stored in the external device, and a control unit that returns the image forming apparatus from the second power state to the first power state if the determination unit determines that a print job of the logged-in user exists in the external device.

### BACKGROUND

1. Field

Aspects of the present invention generally relate to an image forming apparatus, a method for controlling the image forming apparatus, and a storage medium.

2. Description of the Related Art

Some known image forming apparatuses, in a power-saving mode in which power consumption is reduced to a low level, activate only a functional part corresponding to a function that a user has selected by means of icons in a user interface (UI) of an operation panel (see Japanese Patent Application Laid-Open No. 2011-180261). Since the electric power is not supplied to parts other than the selected functional part, unnecessary power consumption can be reduced.

In the known technique, however, the activation of the functional part is started after the function selection is performed by the user, and it takes time to complete the initialization of the functional part until the user can operate the apparatus. This makes the user wait until the necessary processing is completed.

### SUMMARY

An aspect of the present invention is generally directed to a system capable of precisely controlling power supply state of individual devices by detecting an operator approaching a body, performing authentication, and checking whether a print job of the authenticated operator has been registered outside, which reduces the time for starting printing of a print job while consuming lower power.

According to an aspect of the present disclosure, an image forming apparatus capable of communicating with an external device storing a print job received from an information processing apparatus includes a reception unit configured to receive a user login request for logging in to the image forming apparatus, a determination unit configured to determine whether a print job of a user logged into the image forming apparatus is stored in the external device, and a control unit configured to return the image forming apparatus from a second power state to a first power state if the determination unit determines that a print job of the logged-in user exists in the external device.

Further features of the present disclosure will become apparent from the following description of exemplary embodiments with reference to the attached drawings.

### BRIEF DESCRIPTION OF THE DRAWINGS

FIG. 1 is a block diagram illustrating a configuration of a system including an image forming apparatus.

FIG. 2 is a block diagram illustrating an example of a configuration of the multifunction peripheral illustrated in FIG. 1.

FIG. 3 is a block diagram illustrating an example of a configuration of the control unit illustrated in FIG. 2.

FIG. 4 is a block diagram illustrating an example of a configuration of the operation unit illustrated in FIG. 2.

FIG. 5 is a timing chart illustrating transition of power states of a multifunction peripheral.

FIG. 6 is an external view of the operation unit illustrated in FIG. 2.

FIG. 7 illustrates job information to be displayed on the display unit illustrated in FIG. 4.

FIG. 8 is a flowchart illustrating a data processing method in an information processing apparatus.

FIG. 9 is a flowchart illustrating a data processing method in a server device.

FIGS. 10A and 10B are a flowchart illustrating a control method for an image forming apparatus.

FIG. 11 is a flowchart illustrating a data processing method in a server device.

FIG. 12 is a block diagram illustrating a configuration of a system including an image forming apparatus.

FIG. 13 is a flowchart illustrating a control method for an image forming apparatus.

FIG. 14 is a flowchart illustrating a control method for an image forming apparatus.

FIGS. 15A and 15B are a flowchart illustrating a control method for an image forming apparatus.

### DESCRIPTION OF THE EMBODIMENTS

Hereinafter, exemplary embodiments will be described with reference to the attached drawings. In the exemplary embodiments, a multifunction peripheral (MFP) is described as an example of an image forming apparatus.

### <Description of System Configuration>

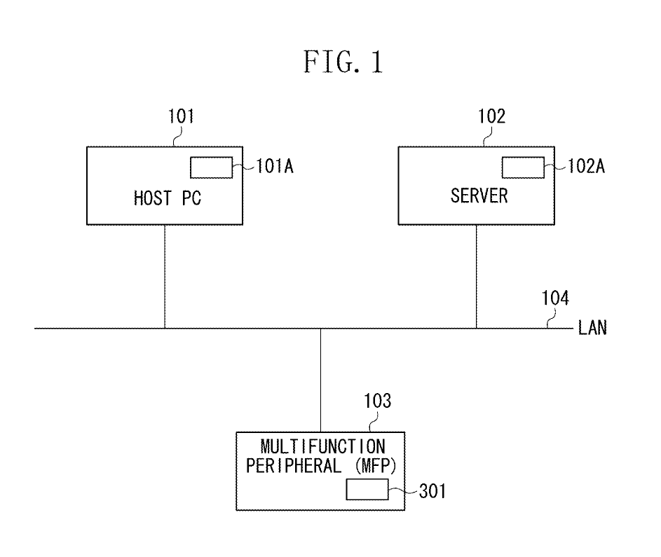

Hereinafter, the first exemplary embodiment is described. FIG. 1 is a block diagram illustrating a configuration of a system including an image forming apparatus according to the exemplary embodiment. Unless otherwise stated, as long as the functions according to the exemplary embodiments can be implemented, the exemplary embodiments can be applied to any single device, or any system including a plurality of devices. Moreover, unless otherwise stated, as long as the functions according to the exemplary embodiments can be implemented, the exemplary embodiments can be applied to a system in which connection and processing can be performed via a network such as a wide area network (WAN) and a local area network (LAN).

In FIG. 1, a host personal computer (PC) 101 includes a controller having a central processing unit (CPU) 101A. The host PC 101 generates a print job that causes an MFP 103 to output a print product of a document containing images, characters, or the like according to an instruction from a user, and sends the print job to a server 102. The server 102 includes a controller having a CPU 102A. The server 102 stores the print job received from the host PC 101 together with time data corresponding to the date and time when the print job has been received, name, data and size of the print job, and the like in an internal storage area (not illustrated) as user information associated with the user. If the server 102 receives from the MFP 103 a request for inquiring user information associated with any user, the server 102 searches a storage area (not illustrated) for the information, and sends the result and user information to the MFP 103. If the server 102 receives a request for sending a print job from the MFP 103 provided with a control unit having a CPU 301, which will be described below in detail, the server 102 sends the print job to the MFP 103. The MFP 103 includes a printer, a scanner, an operation unit, and a communication unit having a communication interface (network I/F).

The MFP 103 includes devices for implementing functions such as copy, scan, facsimile (FAX), print, and user authentication. The MFP 103 sends a user information inquiry to the server 102, and if there is the user information associated with the user, the MFP 103 receives the user information and prints it. A local area network (LAN) 104 connects the host PC 101, the server 102, the MFP 103, and other devices to each other to enable communication among each device.

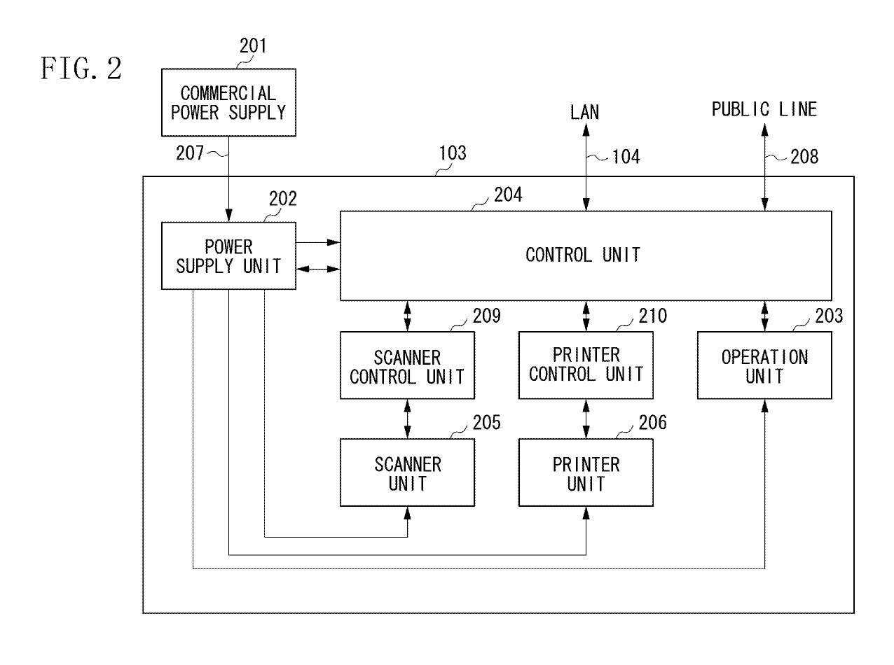

FIG. 2 is a block diagram illustrating an example of a configuration of the MFP 103 illustrated in FIG. 1.

In FIG. 2, a commercial power supply 201 supplies electric power to the MFP 103. A power supply unit 202 rectifies and transforms an alternating voltage 207 to a direct voltage, and supplies it to each unit. An operation unit 203 receives an operation from a user, and displays the information about the MFP 103 and other information. A control unit 204 controls the entire MFP 103, and communicates with an external device via the LAN 104 and a public line 208. The control unit 204 also processes image data to be handled in a scanner unit 209 and a printer control unit 210. A scanner unit 205 sends image data read from a paper original to the scanner control unit 209.

A printer unit 206 forms on paper an image of image data received from the printer control unit 210. The alternating voltage 207 is supplied from the commercial power supply 201 to the power supply unit 202. The scanner control unit 209 controls a scanner. The printer control unit 210 controls a printer unit.

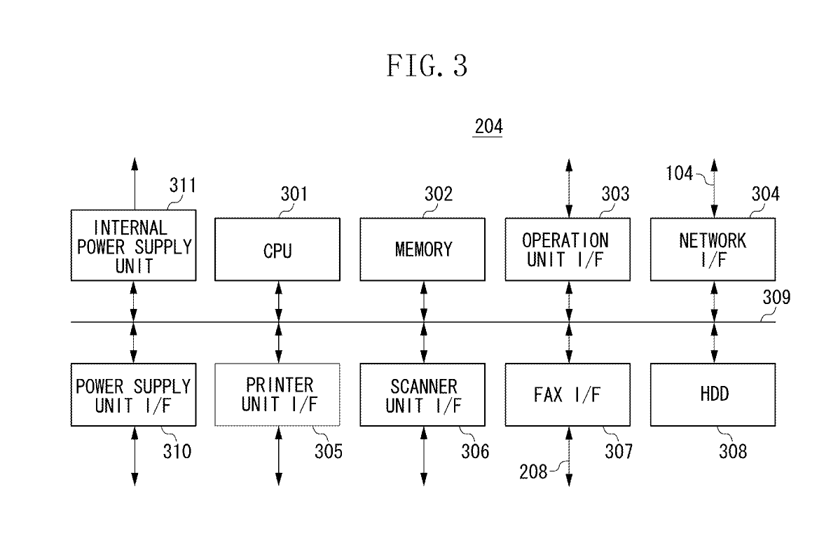

FIG. 3 is a block diagram illustrating an example of a configuration of the control unit 204 illustrated in FIG. 2.

In FIG. 3, a CPU 301 functions as a controller of the entire MFP 103. A memory 302 temporarily stores a program to be executed in the CPU 301, setting information, and image data. An operation unit I/F 303 communicates with the operating unit 203. A network I/F 304 communicates with an external device via the LAN 104. A printer unit I/F 305 communicates with the printer control unit 210. A scanner unit I/F 306 communicates with the scanner control unit 209. A FAX I/F 307 sends or receives FAX data to/from an external device via the public line 208. A hard disk drive (HDD) 308 stores image data and a print job. The HDD 308 can store a boot program for booting the MFP 103. The HDD 308 can also store log information about the apparatus. An internal signal bus 309 connects each unit to enable the intercommunication. A power supply unit I/F 310 communicates with the power supply unit 202, issues an instruction to turn on or off the power supply to each unit, and receives a state of the power supply to each unit. An internal power supply unit 311 supplies the electric power supplied from the power supply unit 202 to each unit in the control unit 204. According to an instruction of the CPU 301, the internal power supply unit 311 turns on or off the power supply to each unit.

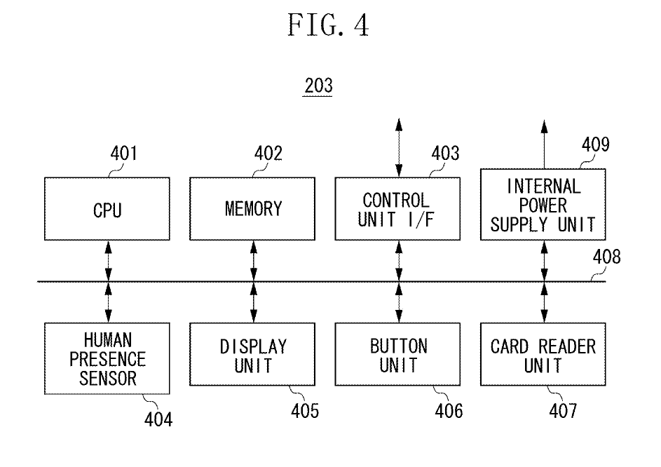

FIG. 4 is a block diagram illustrating an example of a configuration of the operation unit provided in the MFP illustrated in FIG. 1.

In FIG. 4, a CPU 401 controls the entire operation unit. A memory 402 stores a program to be executed by the CPU 401, setting information, and image information to be displayed on a display unit 405. A control unit I/F 403 connects and communicates with the control unit 204. A human presence sensor 404 detects a person (operator) around the MFP 103. If the human presence sensor 404 detects a person approaching the body of the MFP 103, the human presence sensor 404 sends a signal to make a notification to the CPU 401.

The configuration and detection method for the human presence sensor 404 can be an infrared reflection type, a pyroelectric type, a Doppler type, or a type combining a camera and an image processing unit for detecting a person. The display unit 405 displays information about the MFP 103. A button unit 406 receives an operation from a user. A card reader unit 407 reads information recorded on a card and stores the information in the memory 402 via the CPU 401 or directly. The card reader can employ any method, for example, a contact type or a noncontact type. An internal signal bus 408 connects each unit to enable the intercommunication. An internal power supply unit 409 supplies the electric power supplied from the power supply unit 202 to each unit within the operation unit 203. According to an instruction of the CPU 401, the internal power supply unit 409 turns on or off the power supply to each unit

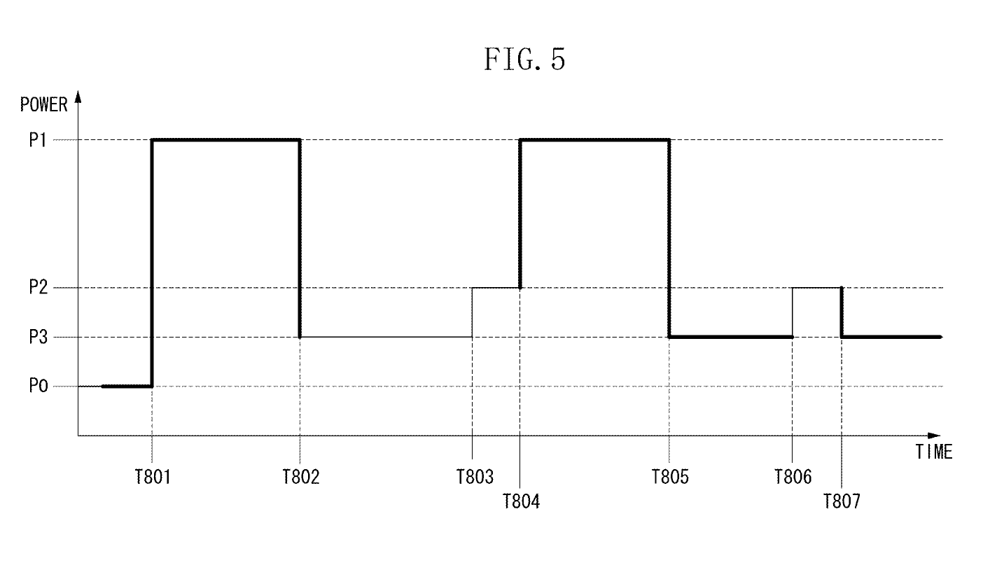

FIG. 5 is a timing chart illustrating an example of transition of power states of the MFP 103 illustrated in FIG. 1.

In FIG. 5, a power state P0 indicates that the power consumption is “0” and the power supply is “OFF”. A power state P1 indicates a first power state in which image formation can be performed. In the power state P1, the electric power is being supplied from the power supply unit 202 to the control unit 204, the scanner unit 205, the printer unit 206, the operation unit 203, the scanner control unit 209, and the printer control unit 210 in the MFP 103. In the first power state P1, functions of print, scanner, copy, fax, user authentication, and network communication in the MFP 103 can be performed. In the first power state P1, however, the large power is consumed in the MFP 103.

A power state P2 indicates a second power state. In the power state P2, the electric power is being supplied to the control unit 204, the operation unit 203, the scanner control unit 209, and the printer control unit 210. In this state, authentication can be received from a user via the operation unit 203. Moreover, via the network I/F 304, the MFP 103 can communicate with the server 102. The MFP 103 can also display function icons on the display unit 405 of the operation unit 203, and select a function according to an operation of a user.

In the second power state P2, the power consumption can be reduced by stopping the power supply to the scanner unit 205, which consumes a relatively large electric power for motor drive in a sheet feeding mechanism, and the printer unit 206, which consumes a relatively large electric power for motor drive in a sheet feeding mechanism and image formation. Since the electric power is supplied to the scanner control unit 209 and the printer control unit 210, the second power state P2 has the advantage that its transition time to the state P1 is shorter than the transition from the state P0 and a state P3.

The power state P3 indicates a third power state. In this state, the electric power is being supplied to the memory 302 in the control unit 204, the network I/F 304, the CPU 401 in the operation unit 203, the memory 402, the human presence sensor 404, and the button unit 406. In this state, detection of a person by the human presence sensor 404, detection of a pressing operation of the button unit 406 by a user, and detection of packets from the LAN 104 can be performed. Since only minimum electric power is consumed, the power consumption can be largely reduced. Hereinafter, timings of the transition are described.

A timing T801 indicates the timing of when the power supply is turned on and the state changes from the power state P0 to the first power state P1. A timing T802 indicates the timing of when the state changes from the first power state P1 to the third power state P3.

A timing T803 indicates the timing of when the state changes from the third power state P3 to the second power state P2. A timing T804 indicates the timing of when the state changes from the second power state P2 to the first power state P1. A timing T805 indicates the timing of when the state changes from the first power state P1 to the third power state P3 again. A timing T806 indicates the timing of when the state changes from the third power state P3 to the second power state P2 again. A timing T807 indicates the timing of when the state changes from the second power state P2 to the third power state P3.

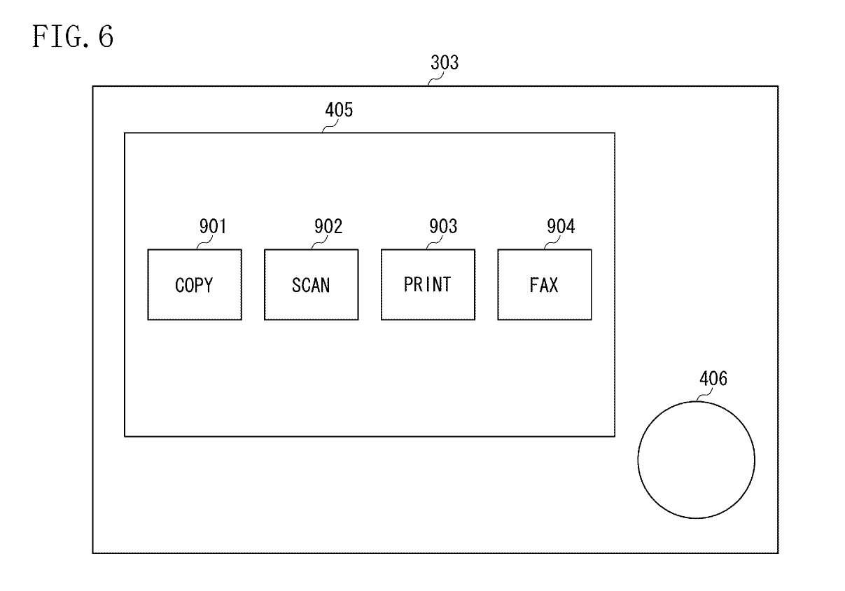

FIG. 6 is an external view of the operation unit 203 illustrated in FIG. 2.

In FIG. 6, a copy icon 901 is used to select a copy function by an operation of a user. A scan icon 902 is used to select a scan function by an operation of a user. A print icon 903 is used to select a print function by an operation of a user. A fax icon 904 is used to select a fax function by an operation of a user.

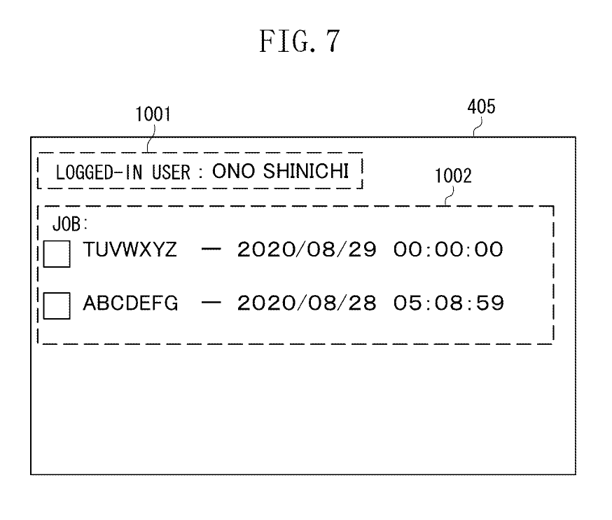

FIG. 7 illustrates an example of job information to be displayed on the display unit 405 illustrated in FIG. 4.

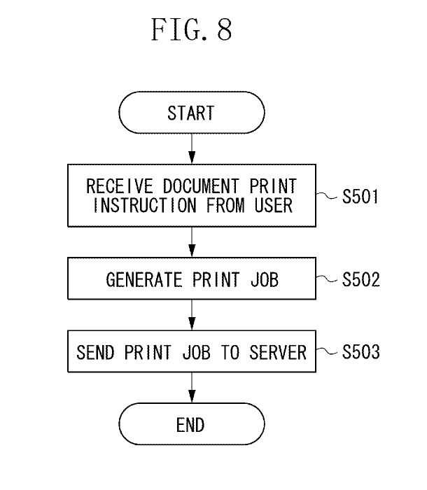

In FIG. 7, a logged-in user 1001 indicates a name of a user authenticated and logged in the MFP. A job list 1002 is a print job list of the logged-in user stored in the server 102. Each print job has a job name, and time data corresponding to date and time when the print job has been sent to the server 102. A print job is selected by an operation of the user. With reference to the flowchart in FIG. 8, a print job transmission processing performed by the host PC 101 according to the exemplary embodiment is described.

FIG. 8 is a flowchart illustrating a data processing method in an information processing apparatus according to the exemplary embodiment. This example is print job transmission processing example in the host PC 101. Each step is carried out by starting and executing a stored driver (printer driver) by the CPU in the host PC.

In step S501, the host PC 101 receives a document print instruction by an operation of a user. In step S502, the host PC 101 converts the relevant data into image data by a printer driver stored in advance in a storage area (not illustrated), and generates a print job including the image data by adding information such as user information and setting information. In step S503, the printer driver sends the print job via the LAN 104 to the server 102. In a case a plurality of servers 102 is connected to the LAN 104, the server can be selected by setting a predetermined server to the printer driver in advance, or a server can be selected by a user in each print job transmission.

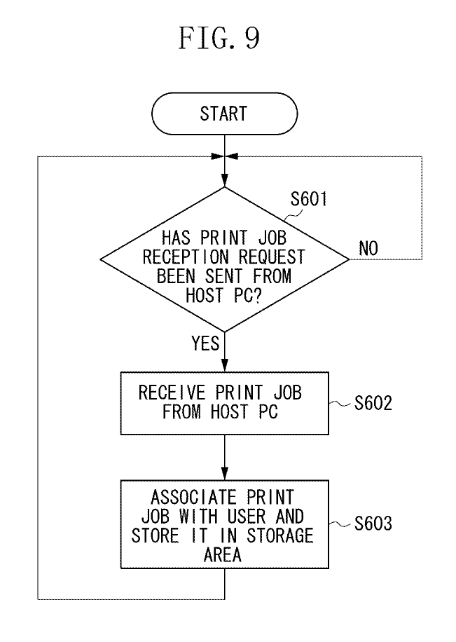

FIG. 9 is a flowchart illustrating a data processing method in the server device according to the exemplary embodiment. This example is example print job reception processing performed by the server 102 illustrated in FIG. 1. Each step is carried out by the CPU in the server 102 executing a stored control program.

In step S601, the CPU in the server 102 waits for a print job reception request from the host PC 101. In step S602, the CPU in the server 102 receives a print job from the host PC 101 via the LAN 104. In step S603, the CPU in the server 102 refers to the user information included in the print job, associates the print job with the user information, and stores the associated information in a storage area (not illustrated). A print job received from another user is similarly associated with the user information, and stored in the storage area (not illustrated).

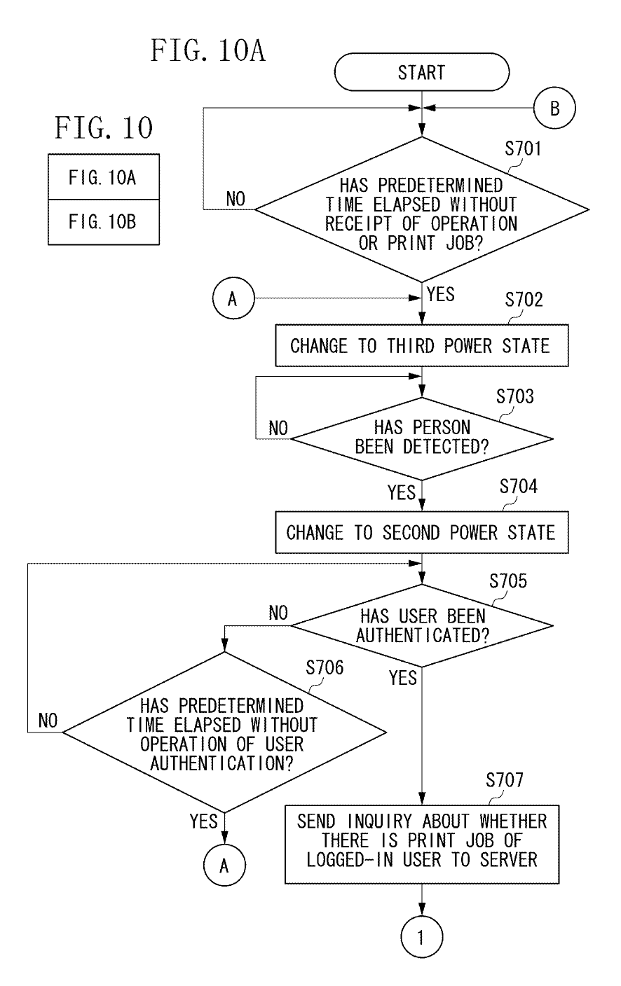

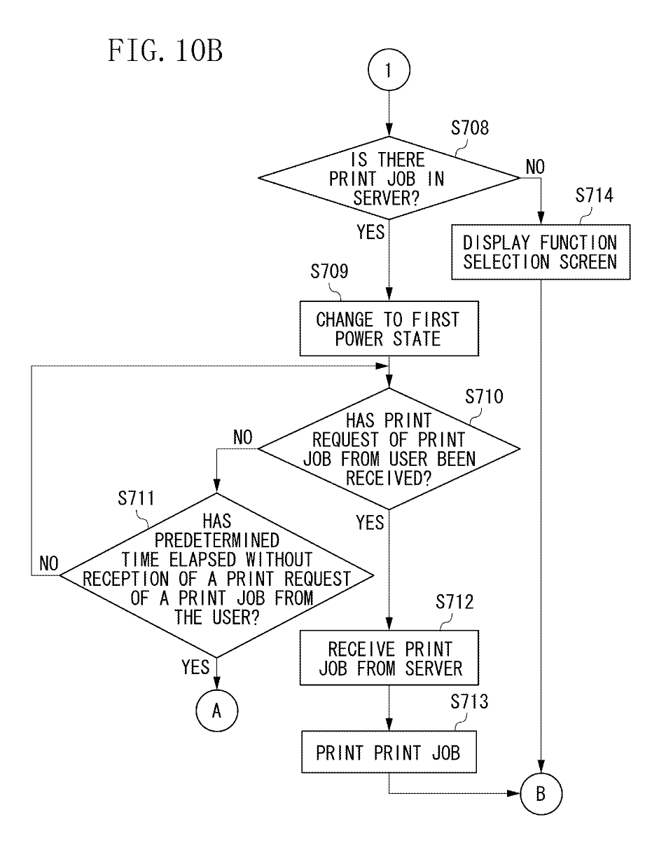

FIGS. 10A and 10B are a flowchart illustrating a method for controlling the image forming apparatus according to the exemplary embodiment. This example is example job processing performed by the MFP 103 illustrated in FIG. 1. Each step is carried out by the CPU 301 executing a stored control program.

In step S701, when the power supply to the MFP 103 is turned on, and the power state is in the first power state P1 between the timing T801 and the timing T802 illustrated in FIG. 5, the CPU 301 in the control unit 204 determines whether a predetermined time has elapsed without receiving an operation by a user or a print job. If the CPU 301 determines that a predetermined time has elapsed without receiving a print job (YES in step S701), then in step S702, at the timing 802, the CPU 301 issues to the power supply unit 202 via the power supply unit I/F 310 an instruction to change the power state to the third power state P3 illustrated in FIG. 5.

Alternatively, at a preset time, or in response to an operation of the operation unit 203 performed by a user, the power state can be changed to the third power state P3.

In step S703, the CPU 301 keeps monitoring whether a person approaching the MFP 103 has been detected by the human presence sensor 404 provided near the operation unit 203.

If the CPU 301 determines that a person has been detected (YES in step S703), then in step S704, at the timing 803, the CPU 301 issues to the power supply unit 202 an instruction to change the power state to the second power state P2.

Alternatively, in response to a pressing operation of the button unit 406 on the operation unit 203 by a user, the power state can be changed to the second power state P2.

In step S705, if the card reader unit 407 detects that a card storing the user information has been waved over the card reader unit 407by the user's operation, the CPU 401 reads the user information and performs authentication (login processing). If the CPU 401 authenticates the user, the processing proceeds to step S707 (YES in step S705).

In step S707, the CPU 301 performs control so that the network I/F 304 can communicate with the server 102 via the LAN 104 and send an inquiry about whether there is a print job of the user who has logged in by the authentication, on the server 102.

In step S708, the CPU 301 determines whether there is a job on the server 102 based on the state of the job storage responded from the server 102. If the CPU 301 determines that there is print job information (YES in step S708), then in step S709, at the timing 804, the CPU 301 issues to the power supply unit 202 an instruction to change the power state to the first power state P1. At the same time, the CPU 301 instructs the display unit 405 to display the print job list illustrated in FIG. 7. In the power state P1, a selected job can be immediately printed. In this exemplary embodiment as an example, whether there is print job information is the condition for transition to the first power state P1, however, the condition is not limited to the print job information. For example, other than the print job information, the transition can be made based on whether there is a print job transmitted by the user to the server 102 within a predetermined time, or the transition can be made based on information obtained by processing a history of print jobs transmitted by the user to the server 102, using a statistical method.

In step S710, the CPU 301 monitors reception of a print request of a print job from the user. If the CPU 301 receives a print request of a print job selected by the user (YES in step S710), then in step S712, the CPU 301 sends a print job transmission request to the server 102 and receives the print job from the server 102. In step S713, the CPU 301 sends image data included in the print job received from the server 102 to the printer unit 206 via the printer unit I/F 305, and the printer unit 206 executes the printing.

Meanwhile, in step S708, if the CPU 301 determines that there is no print job on the server 102 (NO in step S708), then in step S714, the CPU 301 displays the function selection screen illustrated in FIG. 6 via the control unit I/F 403 in the operation unit 203. Then, in step S701, the CPU 301 waits for an operation by a user or reception of a print job. In this operation, the second power state P2 is maintained.

In step S706, if the CPU 301 determines that a predetermined time has elapsed without an operation of user authentication (YES in step S706), then in step S702, at the timing 807, the CPU 301 issues an instruction to the power supply unit 202 to change the power state to the third power state P3. In step S711, if the CPU 301 determines that the predetermined time has elapsed without reception of a print request of a print job from the user (YES in step S711), then in step S702, at the timing T805, the CPU 301 issues an instruction to the power supply unit 202 to change the power state to the third power state P3.

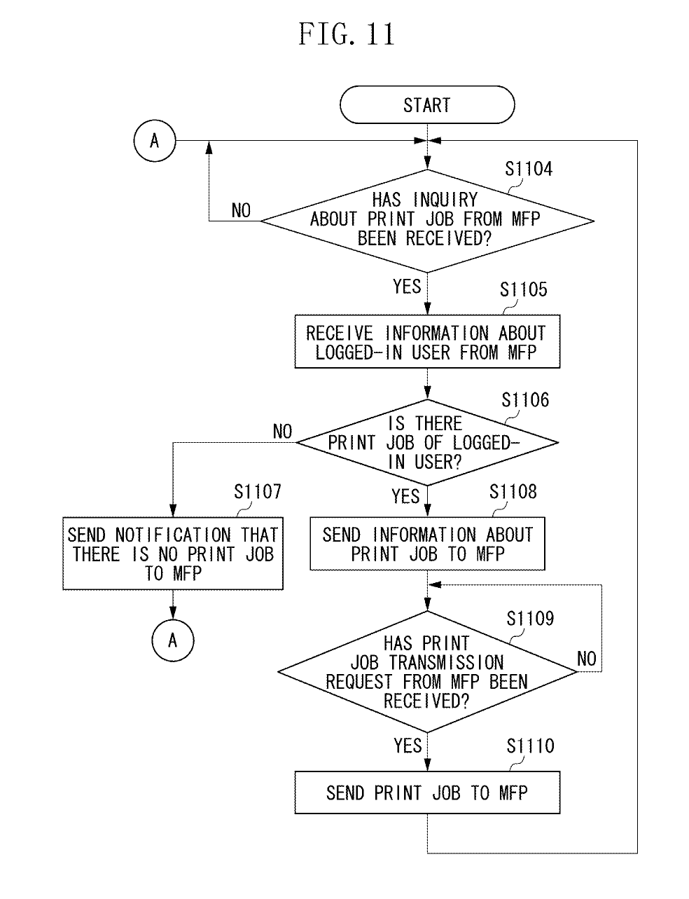

FIG. 11 is a flowchart illustrating a data processing method in a server device according to the exemplary embodiment. This example is an example print job transmission processing performed by the server 102 illustrated in FIG. 1. Each step is carried out by the CPU 102A executing a stored control program in the server 102.

In step S1104, the CPU 102A in the server 102 monitors the presence of an inquiry about a print job from the MFP 103 via the LAN 104. If the CPU 102A determines that there is an inquiry (YES in step S1104), in step S1105, the CPU 102A receives user information about the logged-in user from the MFP 103. In step S1106, the CPU 102A determines whether there is a print job of the logged-in user.

If the CPU 102A determines that there is a print job of the logged-in user (YES in step S1106), then in step S1108, the CPU 102A sends the information about the print job to the MFP 103. In step S1109, the CPU 102A monitors the presence of a print job transmission request. If a print job transmission request has been received (YES in step S1109), then in step S1110, the CPU 102A sends the print job to the MFP 103, and the processing returns to step S1104. Meanwhile, if the CPU 102A determines that there is no print job of the logged-in user (NO in step S1106), in step S1107, the CPU 102A in the server 102 sends, to the MFP 103, the information that there is no print job. In step S1104, the CPU 102A monitors the presence of an inquiry about a print job again.

As described above, if there is a print job on the server 102, electric power is supplied to the printer unit 206, which requires time for startup, without waiting for an operation by the user. Consequently, the user can immediately perform the printing for the print job.

Hereinafter, a second exemplary embodiment is described. In the above-described exemplary embodiment, as an example, the system interconnecting the MFP, server device, and information processing apparatus has been described.

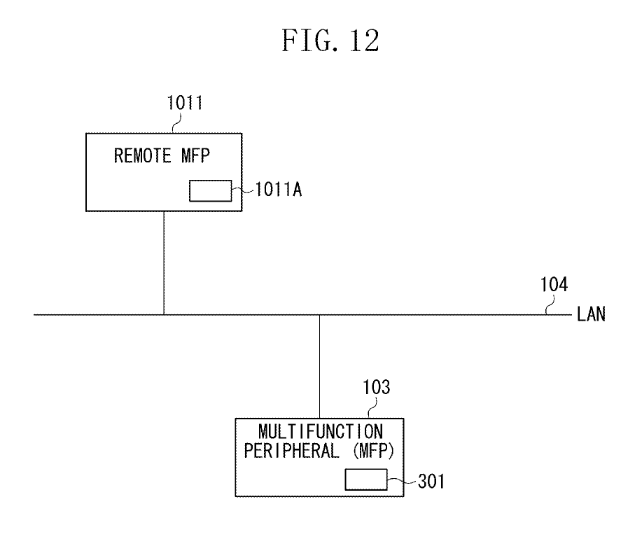

FIG. 12 is a block diagram illustrating a configuration of a system including an image forming apparatus according to the second exemplary embodiment. In this exemplary embodiment, in place of the host PC 101 and the server 102 illustrated in FIG. 1, the MFP is connected with a remote MFP 1011 via a network. The configuration of the remote MFP 1011 is similar to that of the MFP 103 while a part of the control method differs. A CPU 1011A is provided in a controller (not illustrated), and the CPU 1011A controls communication processing, image processing, and other processing of the MFP by executing a stored control program. Hereinafter, copy job generation processing performed by the remote MFP 1011 according to the present exemplary embodiment is described.

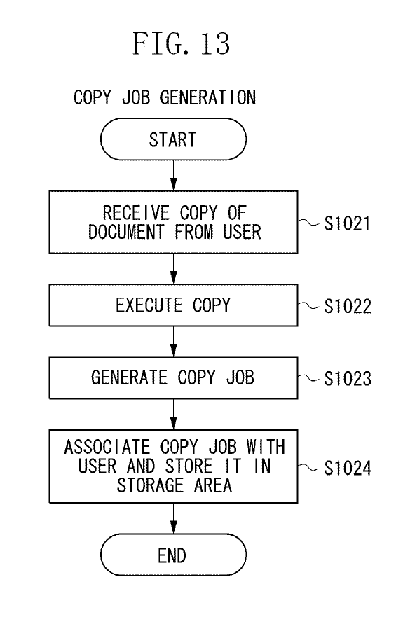

FIG. 13 is a flowchart illustrating a method for controlling an image forming apparatus according to the exemplary embodiment. An example of copy generation processing performed by the remote MFP 1011 is described. Each step is carried out by the CPU 1011A executing a stored control program.

In step S1021, the remote MFP 1011 receives a request for copying a document upon a user's operation, and then, the scanner unit 205 scans the document and converts it into image data. In step S1022, the CPU 301 immediately prints the image data according to settings by the user with the printer unit 206, and completes the copy processing. Simultaneously, in step S1023, the CPU 301 generates a copy job including the image data to which information such as user information and setting information are added. As an example, the setting information includes enlargement/reduction of images, a density of images, a resolution, a sheet size, a finishing method, and the number of copies. In step S1024, the CPU 301 stores the copy job in association with the user in the HDD 308 in the remote MFP 1011, and the processing ends.

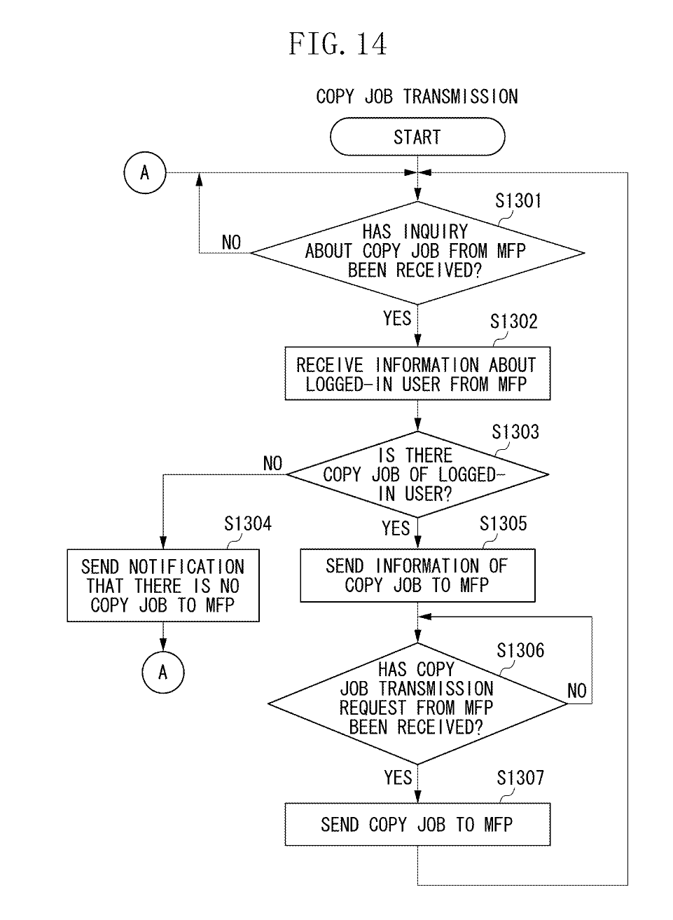

FIG. 14 is a flowchart illustrating a method for controlling an image forming apparatus according to the exemplary embodiment. An example of copy job transmission processing in the remote MFP 1011 is described. Each step is carried out by the CPU 1011A executing a stored control program.

In step S1301, the CPU 1011A in the remote MFP 1011 monitors the presence of an inquiry about a copy job from the MFP 103 via the LAN 104. If the CPU 1011A determines that there is the inquiry (YES in step S1301), then in step S1302, the CPU 1011A receives user information about the logged-in user from the MFP 103.

In step S1303, the CPU 1011A determines whether there is a copy job of the logged-in user. If the CPU 1011A determines that there is a copy job of the logged-in user (YES in step S1303), in step S1305, the CPU 1011A sends the information about the copy job to the MFP 103. In step S1306, the CPU 1011A monitors the presence of an inquiry of a copy job again. In step S1307, the CPU 1011A sends the information about the copy job to the MFP 103, and the processing returns to step S1301.

Meanwhile, if the CPU 1011A determines that there is no copy job of the logged-in user (NO in step S1303), the CPU 1011A in the remote MFP 1011 sends, to the MFP 103, the information that there is no copy job. In step S1301, the CPU 1011A monitors the presence of an inquiry about a copy job again.

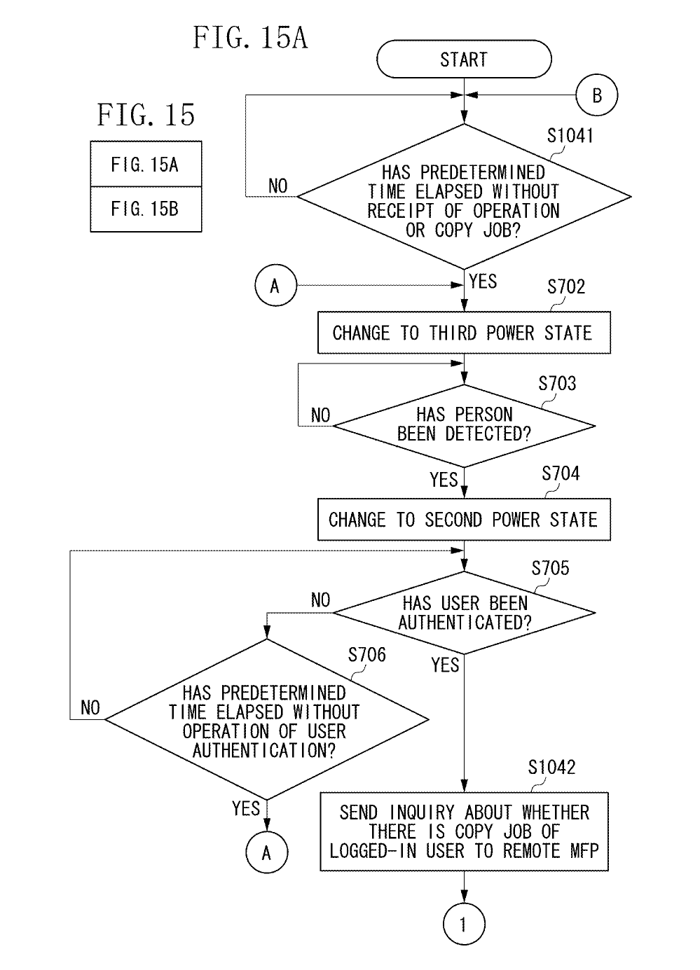

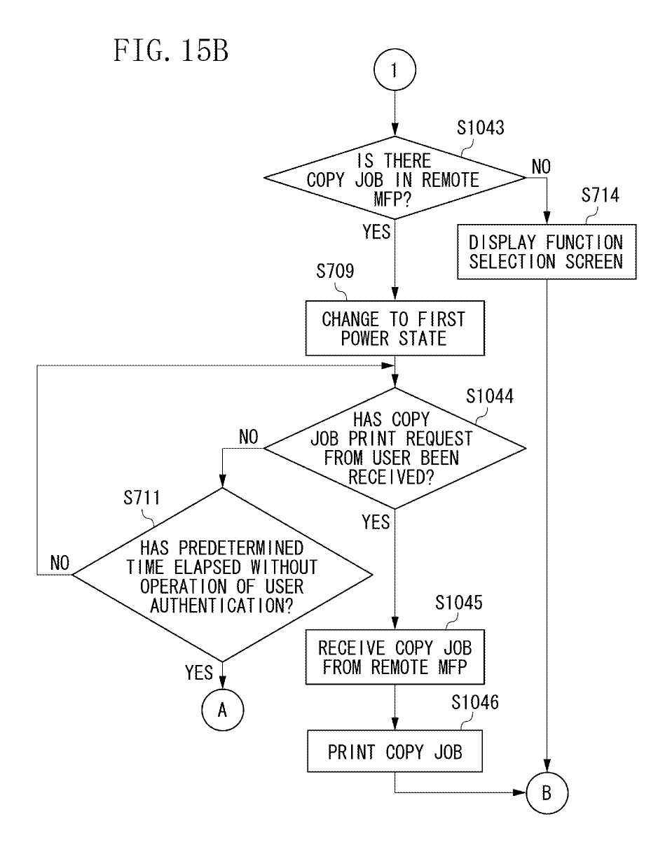

FIGS. 15A and 15B are a flowchart illustrating a method for controlling an image forming apparatus according to the present exemplary embodiment. In this exemplary embodiment, in the image forming apparatus illustrated in FIG. 12, an example of power supply control of the MFP 103 is described. Each step is carried out by the CPU 301 executing a stored control program. The same step numbers are applied to the same steps as those illustrated in FIGS. 10A and 10B.

In step S1041, when the power supply to the MFP 103 is turned on, and the power state is in the first power state P1 between the timing T801 and the timing T802 illustrated in FIG. 5, the CPU 301 in the control unit 204 determines whether a predetermined time has elapsed without reception of an operation by a user or a copy job. If the CPU 301 determines that the predetermined time has elapsed without reception of the copy job (YES in step S1401), then in step S702, at the timing 802, the CPU 301 issues an instruction to change the power state to the third power state P3 illustrated in FIG. 5 to the power supply unit 202 via the power supply unit I/F 310. After that, in step S703, the CPU 301 keeps monitoring whether a person has been detected by the human presence sensor 404.

If the CPU 301 determines that a person approaching the MFP has been detected (YES in step S703), then in step S704, at the timing 803, the CPU 301 issues to the power supply unit 202 an instruction to change the power state to the second power state P2. In step S705, if the card reader unit 407 detects that a card storing the user information has been waved over the card reader unit 407 by the user's operation, the CPU 401 reads the user information and performs authentication (login processing).

In step S1042, the CPU 301 performs control so that the network I/F 304 can communicate with the server 102 via the LAN 104 and send an inquiry about whether there is a copy job of the user who has logged in by the authentication, on the remote MFP 1011.

In step S1043, the CPU 301 determines whether there is copy job information in accordance with the response received from the remote MFP 1011. If the CPU 301 determines that there is copy job information (YES in step S1043), then in step S709, at the timing 804, the CPU 301 issues, to the power supply unit 202, an instruction to change the power state to the first power state P1.

At the same time, the CPU 301 instructs the display unit 405 to display the copy job list illustrated in FIG. 7. In the power state P1, a selected job can be immediately printed. In this exemplary embodiment, as an example, transition to the first power state P1 depends on whether there is copy job information; however, a condition for the transition is not limited to the copy job information. For example, other than the copy job information, information obtained by processing a history of copy jobs transmitted by the user to the remote MFP 1011 using a statistical method can be used.

In step S1044, the CPU 301 monitors the presence of reception of a print request of a copy job from the user. If the CPU 301 receives a print request of a copy job selected by the user (YES in step S1044), then in step S1045, the CPU 301 sends a copy job transmission request to the remote MFP 1011, and receives the copy job from the remote MFP 1011. In step S1046, the CPU 301 sends image data included in the copy job to the printer unit 206 via the printer unit I/F 305, and the printer unit 206 executes the printing.

Meanwhile, if the CPU 301 determines that there is no copy job (NO in step S1043), then in step S714, the CPU 301 displays the function selection screen illustrated in FIG. 9 via the control unit I/F 403 in the operation unit 203. Then, in step S1041, the CPU 301 waits for an operation by a user or reception of a copy job.

If the CPU 301 determines that a predetermined time has elapsed without an operation of user authentication (YES in step S706), then in step S702, at the timing 807, the CPU 301 issues an instruction to the power supply unit 202 to change the power state to the third power state P3. If the CPU 301 determines that a predetermined time has elapsed without reception of a print request of a copy job from the user (YES in step S711), then in step S702, at the timing T805, the CPU 301 issues an instruction to the power supply unit 202 to change the power state to the third power state P3.

As described above, if there is a copy job on the remote MFP 1011, electric power is supplied, without waiting for an operation by the user, to the printer unit 206, which requires time for startup. Consequently, the user can immediately perform the printing of the print job. Moreover, no server is necessary, and the configuration can be readily provided.

### OTHER EMBODIMENTS

Additional embodiments of the present invention can also be realized by a computer of a system or apparatus that reads out and executes computer executable instructions recorded on a storage medium (e.g., computer-readable storage medium) to perform the functions of one or more of the above-described embodiment(s), and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that these exemplary embodiments are not seen to be limiting. The scope of the following claims is to be accorded the broadest interpretation so as to encompass all such modifications and equivalent structures and functions.

This application claims the benefit of Japanese Patent Application No. 2013-051412 filed Mar. 14, 2014, which is hereby incorporated by reference herein in its entirety.

What is claimed is:

1. An image forming apparatus capable of communicating with an external device storing a print job received from an information processing apparatus, the image forming apparatus comprising:
a reception unit configured to receive a user login request for logging in to the image forming apparatus;
a determination unit configured to determine whether a print job of a user logged into the image forming apparatus is stored in the external device; and
a control unit configured to return the image forming apparatus from a second power state to a first power state if the determination unit determines that a print job of the logged-in user exists in the external device.

2. The image forming apparatus according to claim 1, further comprising:
a printing unit configured to print an image onto a sheet,
wherein in the first power state, the printing unit can perform printing.

3. The image forming apparatus according to claim 1, wherein the reception unit is a card reader configured to read information stored on a card.

4. The image forming apparatus according to claim 1, wherein the control unit keeps the image forming apparatus in the second power state if the determination unit determines that no print job of the logged-in user exists in the external device.

5. The image forming apparatus according to claim 1, further comprising:
a detection unit configured to detect a person, wherein the control unit returns the image forming apparatus from a third power state to the second power state if the detection unit detects a person, and
wherein the control unit returns the image forming apparatus from the second power state to the first power state if the reception unit receives the user login request in the second power state and the determination unit determines that a print job of the logged-in user exists in the external device.

6. The image forming apparatus according to claim 1, further comprising:
an instruction unit configured to instruct to make a request for executing the print job stored in the external device;
an acquiring unit configured to acquire the print job from the external device according to the request for executing the print job; and
a printing unit configured to execute the printing according to the acquired print job.

7. A method for controlling an image forming apparatus capable of communicating with an external device storing a print job received from an information processing apparatus, the method comprising:
receiving a user login request for logging in to the image forming apparatus;
determining whether a print job of the user logged into the image forming apparatus is stored in the external device; and
returning the image forming apparatus from a second power state to a first power state if it is determined that a print job of the logged-in user exists in the external device.

8. The method for controlling the image forming apparatus according to claim 7, further comprising printing, when in the first power state, an image onto a sheet.

9. The method for controlling the image forming apparatus according to claim 7, further comprising reading information associated with a user stored on a card and logging the user into the image forming apparatus based on the read information.

10. The method for controlling the image forming apparatus according to claim 7, further comprising keeping the image forming apparatus in the second power state if it is determined that no print job of the logged-in user exists in the external device.

11. The method for controlling the image forming apparatus according to claim 7, further comprising:
detecting a person; and
returning the image forming apparatus from a third power state to the second power state if a person is detected,
wherein the image forming apparatus returns from the second power state to the first power state if the user login request is received in the second power state and it is determined that a print job of the logged-in user exists in the external device.

12. The method for controlling the image forming apparatus according to claim 7, further comprising:
instructing to make a request for executing the print job stored in the external device;
acquiring the print job from the external device according to the instructed request for executing the print job; and
performing the printing according to the acquired print job.

13. A computer readable storage medium storing computer executable instructions that cause a computer to execute a method for controlling an image forming apparatus capable of communicating with an external device storing a print job received from an information processing apparatus, the method comprising:
receiving a user login request for logging in to the image forming apparatus;
determining whether a print job of the user logged into the image forming apparatus is stored in the external device; and
returning the image forming apparatus from a second power state to a first power state if it is determined that a print job of the logged-in user exists in the external device.
